(19) United States
(12) Patent Application Publication
(10) Pub. No.: US 2014/0114986 A1
(43) Pub. Date: Apr. 24, 2014

(54) METHOD AND APPARATUS FOR IMPLICIT TOPIC EXTRACTION USED IN AN ONLINE CONSULTATION SYSTEM

(71) Applicant: Pearl.com LLC, San Francisco, CA (US)

(72) Inventors: Gann Bierner, Oakland, CA (US); Ashkan Gholam Zadeh, San Francisco, CA (US)

(21) Appl. No.: 13/946,982

(22) Filed: Jul. 19, 2013

Related U.S. Application Data
(63) Continuation-in-part of application No. 12/854,846, filed on Aug. 11, 2010.
Application No. 12/854,846 is a continuation-in-part of application No. 12/854,838, filed on Aug. 11, 2010.
Application No. 12/854,838 is a continuation-in-part of application No. 13/439,743, filed on Apr. 4, 2012.
Application No. 13/439,743 is a continuation of application No. 12/854,849, filed on Aug. 11, 2010, now abandoned.
Application No. 12/854,849 is a continuation-in-part of application No. 13/464,230, filed on May 4, 2012.
(60) Provisional application No. 61/233,046, filed on Aug. 11, 2009.
(60) Provisional application No. 61/233,046, filed on Aug. 11, 2009.
(60) Provisional application No. 61/233,046, filed on Aug. 11, 2009.

(51) Int. Cl. G06F 17/30

(52) U.S. Cl. CPC G06F 17/30716
USPC 707/748

(57) ABSTRACT

Embodiments of the present invention further provide systems and methods for automatically identifying and extracting topics implicit in the content under analysis.

### RELATED APPLICATIONS

The present application is a Continuation-in-Part of U.S. patent application Ser. No. 12/854,846 filed on Aug. 11, 2010; U.S. patent application Ser. No. 12/854,838 filed on Aug. 11, 2010; U.S. patent application Ser. No. 13/439,743 filed on Apr. 4, 2012, which in turn is a Continuation of U.S. patent application Ser. No. 12/854,849 filed on Aug. 11, 2010, all of which claim priority to U.S. Provisional Application No. 61/233,046 filed on Aug. 11, 2009, all of which are incorporated herein by reference.

The present application is also a Continuation-In-Part of U.S. patent application Ser. No. 13/464,230 filed on May 4, 2012, and is incorporated herein by reference.

### FIELD

The present application relates generally to the field of computer technology and, in specific exemplary embodiments, to methods and systems for implicitly extracting topics present in various contents.

### BACKGROUND

Presently, many online websites allow for exchange of information. Some of these websites provide a question and answer type capability whereby a user may post a question and one or more other users may reply. Often, any user on the Internet may be able to post the reply. Success of the online consultation system is based on the quality of service it provides. The quality of service is dependent on having adequate numbers of qualified experts available in relevant topics, in order to provide timely responses to user asked questions.

An exemplary online consultation system is described in detail in U.S. patent application Ser. No. 12/854,846 filed on Aug. 11, 2010. In the exemplary online consultation system 102, a user posts his or her question to one of several hundreds of subject matter categories and subcategories by accessing the online consultation website and 102. The user may select a subject category relevant to the posted question. In alternative embodiments, the online consultation system is capable of automatically assign user posted questions to appropriate categories. Each user posted question may include multiple topics and subtopics, and in some cases spanning more than one subject matter category.

In exemplary embodiments of the present invention, user engagement may be promoted by offering free or paid access to the database of questions and answers previously posted to the site. An exemplary platform allowing users and visitors to create and follow their own customized feed based on the topic found in the question and answer archive that may be of interest to them. It would be desirable to be able to create customized feeds by identifying topics present in each content, and adding to the feed only content that includes the selected implicit topics.

### BRIEF DESCRIPTION OF DRAWINGS

The appended drawings are merely used to illustrate exemplary embodiments of the present invention and cannot be considered as limiting its scope.

FIGS. 1A-1C show an exemplary user interface platform to create and personalize a question and answer feeds based on the question and answer threads posted to the online consultation system.

FIG. 2 shows an exemplary flowchart of a method for implicitly identifying topics present in a given content

FIG. 3 is a diagram of an exemplary environment in which embodiments of the present invention may be practiced.

FIG. 4 shows a simplified block diagram of a digital device within which a set of instructions, for causing the machine to perform any one or more of the methodologies discussed herein, may be executed.

### DETAILED DESCRIPTION

The description that follows includes illustrative systems, methods, techniques, instruction sequences, and computing machine program products that embody the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on quality control of experts, the embodiments are given merely for clarity and disclosure. Alternative embodiments may employ other systems and methods and are considered as being within the scope of the present invention.

Embodiments of the present invention provide systems and methods for implicitly identifying and extracting topics found in a given content, allowing the visitors or users to an online consultation system 102 to create content feeds by selecting one or more of topic feeds implicitly identified by the online consultation system 102. In the exemplary embodiments of the present invention, the topics are extracted from stored question and answer threads. In exemplary embodiments, archived question and answer threads are analyzed to identify constituent relevant topics which then may be selected by visitors or users of the online consultation system 102 in creating or editing relevant topic feeds, allowing them to follow a particular subject matter of interest. In certain cases, the visitor arrives at the online consultation site through a search engine. The results of a posted visitor query to a commercial search engine includes organic search results, among which may be search results corresponding to content (e.g. in the case of the online consultation system 100, question and answer thread) found on the online consultation system 102, and a corresponding link to the relevant question and answer threads identified through a search engine crawler. Once the visitor clicks the organic search result link corresponding to a particular question and answer thread, the visitor may be redirected to a landing page displaying the relevant question stored on the online consultation system 102 question and answer archive.

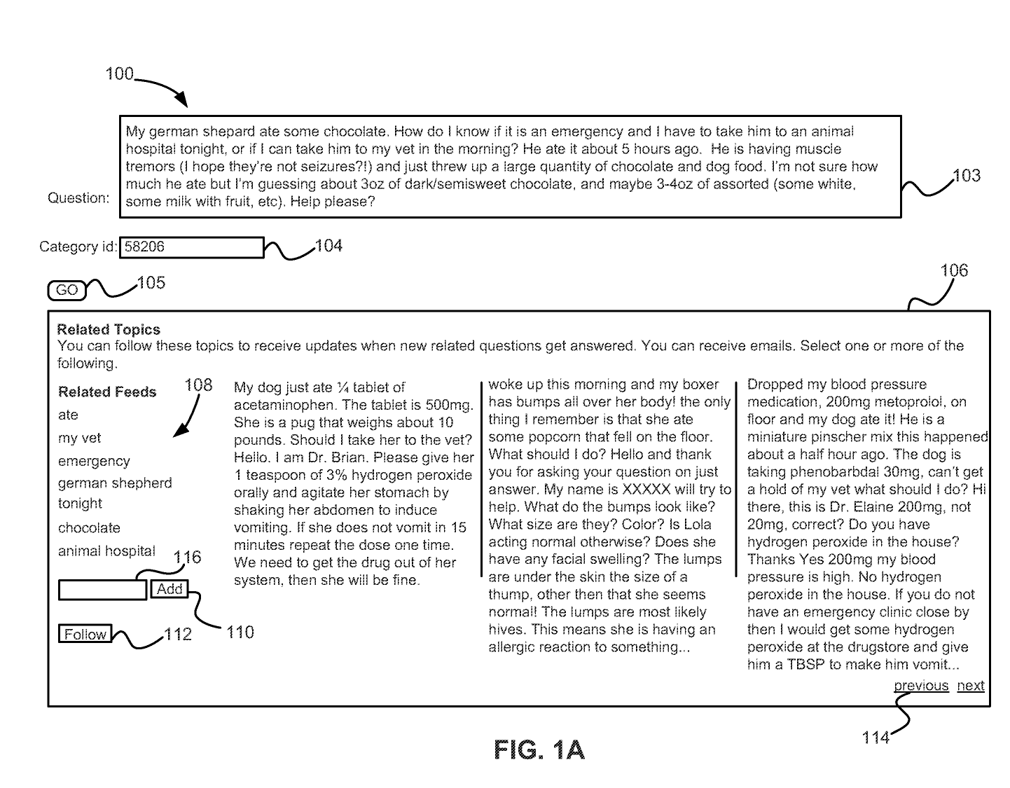

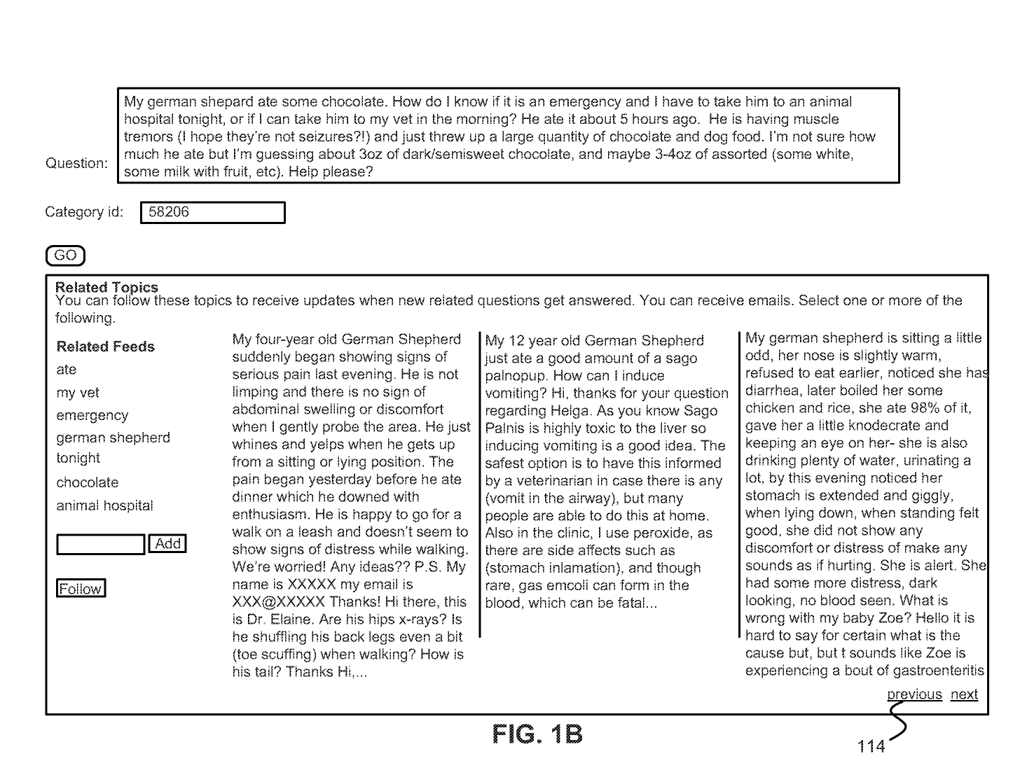

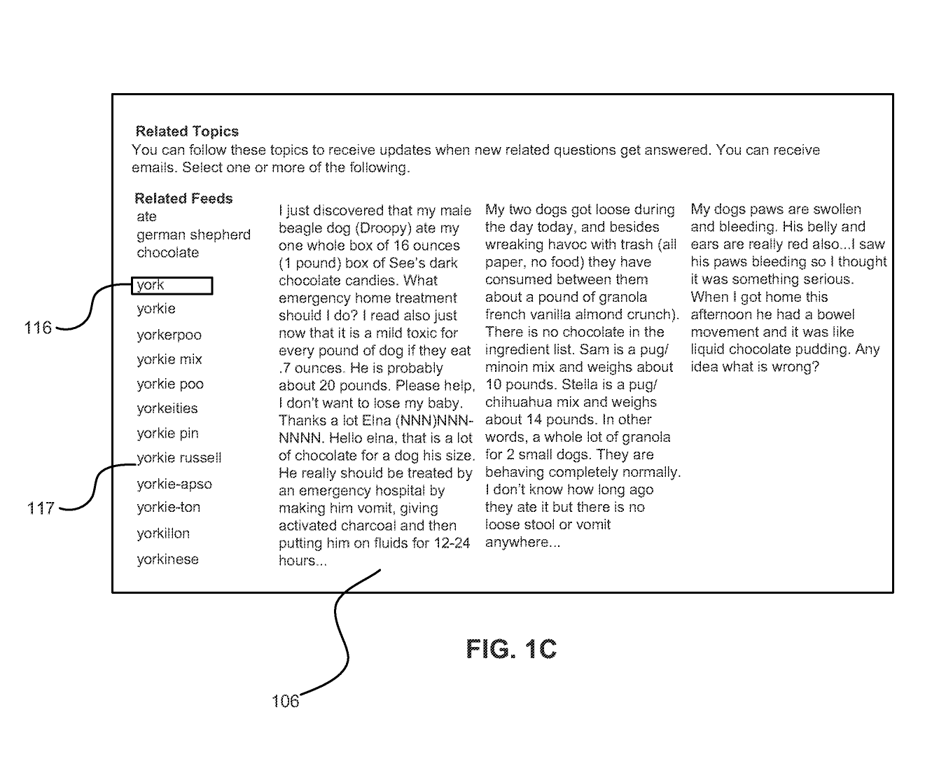

FIGS. 1A-1C show an exemplary user interface platform to create and personalize a question and answer feeds based on the question and answer threads posted to the online consultation system 102. Referring now to FIG. 1, an exemplary feed creation user interface (UI) 101 is shown. The feed creation UI 101 is part of the online consultation system 102 and comprises of an original question display window 103, a category identification window 104, a related topics display window 106 or simply related topics window 106, an intrinsic topic window 108, an extrinsic topic field 116, an extrinsic topic add button 110, a question follow button 112, and navigation link 114.

When a user submits a query to a commercial search engine (e.g. Google® or Bing®), one or more of the organic search results may include at least one question and answer thread posted to the online consultation system 102. In exemplary embodiment of the present invention, when the user clicks on the link displayed as the organic search result of a query posted to the search engine, the link which corresponds to the question and answer search result redirects the user/visitor to the feed creation UI 101 page of the online consultation system 102. In the feed creation UI 101 page, the display window 103 displays an “original question” identified by the search engine in response to user query. The “category Id” field 104 may display identification information corresponding to the subject category corresponding to the question displayed in the question display window 103. The exemplary online consultation system 102 may have hundreds of categories related to different subject matters, each including tens to hundreds of subject matter experts, ready to answer user submitted questions. The related topic display window 106 displays questions that include topic or topics found in the “original question.” The related topics may be based on topics defined implicitly or explicitly. The implicitly identified topics are topics automatically identified by the online consultation system 102 as being present in the “original question” and displayed in the related topic feeds window 108.

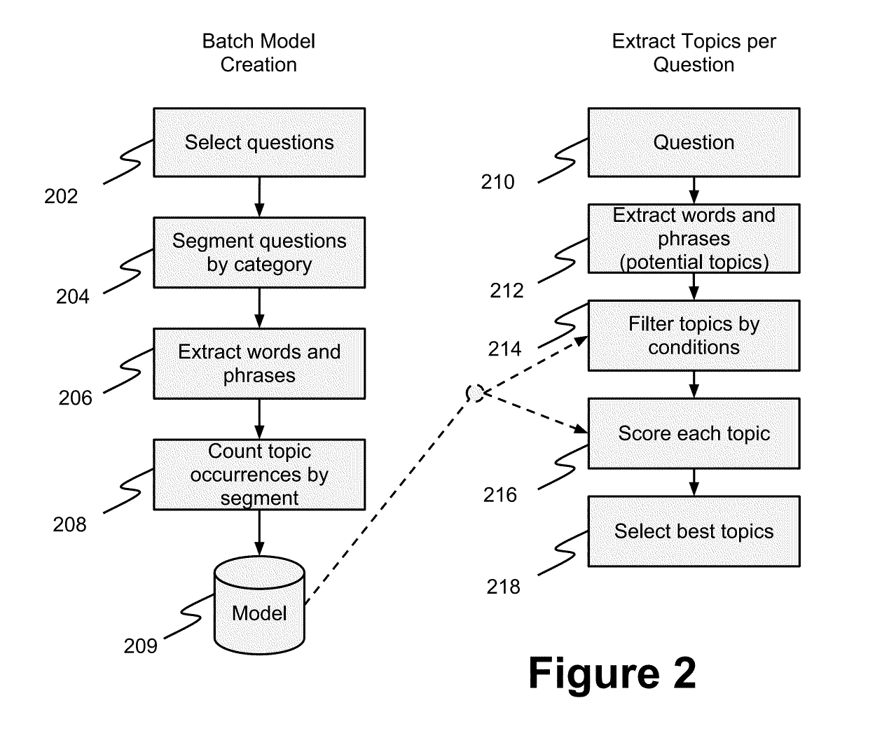

The identification of related content based on implicit topics present in an “original question” is discussed in further detail in FIG. 2.

The explicitly identified topics are topics that are inputted by the visitor in the topic field 110 and submitted by clicking the add button 110. In exemplary embodiments, once the visitor starts typing an explicit topic in the explicit topic field 116, the online consultation system 102 may dynamically and in real-time identify and suggest potential topics based on the characters inputted up to that time. So, for example, as the visitor is typing the characters “vom,” the system may be displaying “vomiting” as a potential explicit topic. In exemplary embodiments of the present invention, once the visitor adds an explicit topic to the list of topics of interest, the explicit topic is added to the list of topics displayed in the related topic field. In exemplary embodiment of the present invention, the related questions that are displayed in the related question window 106 would each contain at least one selected explicit or implicit topic. In alternative embodiments, every question populating the related topics window 106 would include at least one explicitly or implicitly selected related topic. In alternative embodiments, every question populating the related topics window 106 would include all explicitly and implicitly selected related topics. The identification of the related questions based on explicit topics is described in detail in the related US patent application entitled “Method and Apparatus for Creating a Personalized Question Feed Platform”, by Gann Bierner and Ashkan Gholam Zadeh as common inventors, filed on the same day as the present application and herein incorporated by reference.

In exemplary embodiments of the present invention, once the visitor has selected the “implicit” topics that are of interest to him or her and added additional “explicit” topics of interest, by clicking the follow button 112, the visitor causes the consultation system 100 to generate a related question feed including the selected topics. This generation of the question feed comprises the online consultation system 102 to automatically search its database of question and answer threads, identify questions containing the selected topics, and display them in the related question display window 106. In the exemplary embodiment of an online consultation system, the questions used to populate the related topics window 106 are questions previously submitted by users of the online consultation system 102, seeking answers from subject matter experts on a variety of topics in tens or hundreds of categories. It would be apparent to one of skill in the art that the systems and methods of the present invention may be applied to any content database to select topically related content based on implicitly selected topics. In the case of the exemplary online consultation system 102 disclosed herein, the displayed questions include one or more of the same topics present in the “original question” (implicit topics) and/or identified by the visitor (explicit topics) as being of interest. In one example, an Internet user arrives at the online consultation system 102 as a first time visitor by submitting a query to an Internet search engine such as Google® or Bing®. The search engine returns a link to an “original question” identifying it as content that is relevant to the user's query. Once the user clicks the “original question” link, he or she lands on a feed creation landing 101 of the online consultation system 102 as a first time or returning visitor. The “original question” is displayed in the “original question” display window 103, while the related feeds window 108 is automatically populated with the topics contained in the “original question.” The visitor may select one of more of the implicit topics identified to be contained in the “original question,” and/or may add one or more explicit topics of interest that are not contained in the “original question.” The online consultation system 102 automatically searches the previously submitted question database and selects user submitted questions containing the implicit and/or explicit topics identified, displaying them in the related topics window 106.

In the example shown in FIG. 1, the visitor may be interested in the finding the effects of its “Yorkie” having eaten some chocolate. As a result, the visitor may submit the query “dog eat chocolate” to an Internet search engine. The search engine will display a link to the “original question” as containing relevant information. Once the visitor selects the link, he is directed to the visitor landing page 100, where the “original question” relevant to the query “dog eat chocolate” is displayed in the display window 103. The online consultation system 102 automatically identifies and extracts topics present in the “original question,” and displays the extracted topics in the related feeds window 108. As seen in FIG. 1, the related feeds window 108 displays “ate”, “my vet”, “emergency”, “German shepherd”, “tonight”, “chocolate” and “animal hospital” as the first few implicit topics identified as being present in the “original question.” In exemplary embodiments of the present invention, the related feeds topics may be displayed alphabetically, in the order they appear in the “original question” or any other desired order. In alternative embodiments, if there are additional implicit topics that are present in the “original question,” the topics may be displayed through a drop down list that becomes visible when the visitor moves his mouse over the related topic feeds window 108. Furthermore, the visitor of the online consultation system 102 may add related topics explicitly using the “related feed topic” field 116. As a result, the related topic window 106 may displayed previously submitted questions that include the “Yorkie” as a topic, as well as any selected implicit topics, including the topics: “ate,” “chocolate,” “emergency,” etc, and any user added explicit topic.

In exemplary embodiments of the present invention, the contents of the questions in the related topic display window 106 may be adjusted to display the related topics according to the system settings or the user's preference. For example the font size may be adjusted to display more or less content, fewer or more questions, and more or less of a question in at a time. The details of the systems and methods used in the feed creation user interface 100 is further described in the US patent application entitled “Method and Apparatus for Creating a Personalized Question Feed Platform”, by Gann Bierner and Ashkan Gholam Zadeh as common inventors, filed on the same day as the present application and herein incorporated by reference.

FIG. 2 shows an exemplary flowchart of a method for implicitly identifying topics present in a given content.

The database of question and answers posted to the online consultation system 100 includes questions posted by users and answers submitted by subject matter experts in response to the posted question. It would be apparent to one of skilled in the art that the systems and methods described herein may be applied to the entire question and answer thread, or applied to just the question or just the answer component of the question and answer threads.

As shown in the exemplary process flow chart of FIG. 2, the process begins at operation 202 with the selection of a question from the database of questions user posted to the online consultation system 102.

In operation 204, each question is segmented by the category it relates to. For example, a question submitted in the pediatric medicine category is categorized as \such. Posted questions may be categorized by the user submitting the question or by the online consultation system 102. Some questions may be related to more than one category and will be segmented accordingly. In alternative embodiment of the present invention, the question may be associated with a single category deemed to be the best topic category for that question. In operation 206, for each question in the database, the words and phrases present in the question are extracted. The words and phrases extracted from each question include topics that may be eventually identified as relevant topics. In operation 208, for each segment, the number of occurrence of the each topic within that segment is counted. A high occurrence of a topic within a category relative to other categories relates the topic's affinity to the given category. Using the identified and counted topics, in operation 209, a statistical model of all topics occurring in the database of submitted questions is created.

Referring now to the right side of FIG. 2, the flowchart continues with operations that are performed only on the question under analysis as opposed to all the questions in the database of posted questions. In the exemplary embodiment of the feed creation platform of the consultation system 102, the question under analysis would be the “original question.” As previously described, the online consultation system 102 of the present invention may include a topic feed creation tool that allows users of the online consultation system to follow topics of interest posted to the online consultation system. The topics of interest may be identified implicitly by the online consultation system as present in the “original question” selected by the user. Alternatively, the users may explicitly create new topics by adding their own topics of interest to implicit topics found by the online consultation system 102. The focus of the present invention is on the systems and methods of implicitly identifying topics present in the “original question” and identified automatically by the online consultation system 102.

Referring back to FIG. 2, for each “original question 210,” in operation 212, words and phrases present in the “original question” are identified or extracted from the question. In exemplary embodiments, the extraction of words and phrases is performed by a linguistic engine or a Natural Language Processor (NLP). In exemplary embodiments of the present invention, publicly available open source NLP processors could be modified and redesigned to perform the processing described herein. Once such NLP engine and topic extraction in general is the described in detail in the U.S. Pat. No. 8,463,648, entitled “Method and apparatus for automated topic extraction used for the creation and promotion of new categories in a consultation system,” by Gann Bierner and Edwin Cooper, herein incorporated by reference.

A suitable NLP processor may include various modules that divide up the components of a sentence into tokens, a split the sentence and tag speech components. Some of the words and phrases identified by the NLP processor correspond to topics available in each question and further processing will allow to sort and filter out the most likely or useful topics.

So, in operation 214, the words and phrases that were identified as being part of the “original question” are filtered based on the category or subcategory the original question is related to. The filtering uses a set of logical conditions to eliminate or lower the ranking of those words and phrases (candidate topics) that are least likely to correspond to a topic of interest implicit in the “original question” and its corresponding category or subcategory. So, in exemplary embodiments of the present invention, in operation 214, the logical conditions used to filter words and phrases implicit in the “original question” may be based on the number of occurrences of candidate topics. For example, a word or phrase present in the “original question” may be selected only if that word or phrase (candidate topic) has occurred in the category corresponding to the “original question” more than 50 percent. In exemplary embodiments, the filtering is done by calculating the ratio of the number of occurrences of a topic within a category over the number of occurrences of the topic within all categories and only selecting topics that have a ration greater than a given threshold. It would be apparent to one of skill in the art that the logical condition applied to filter the topics must be selected based on the specific design requirements of the system such as the consultation system 102 of the present exemplary embodiment of the present invention.

In operation 216, each filtered topic is scored using a scoring engine. Scoring is applied to all candidate topics across all segments. In exemplary embodiments, the scoring may be based on a modified Term Frequency- Inverse Document Frequency (TFIDF) statistic.

Lastly, in operation 218, the highest score topics are selected as the best or most relevant topics implicitly identified as present in the “original question.”

A successful online consultation system 102 may receive thousands of questions a day and in many dozens or hundreds of categories and sub-categories. Thus, the segmentation of the questions in the multiple categories is preferably done by the system in an automated fashion. It would be apparent to one of skill in the art that it doesn't really matter how the segmentation is done- one just has to know from the question logs which categories the various questions were answered in.

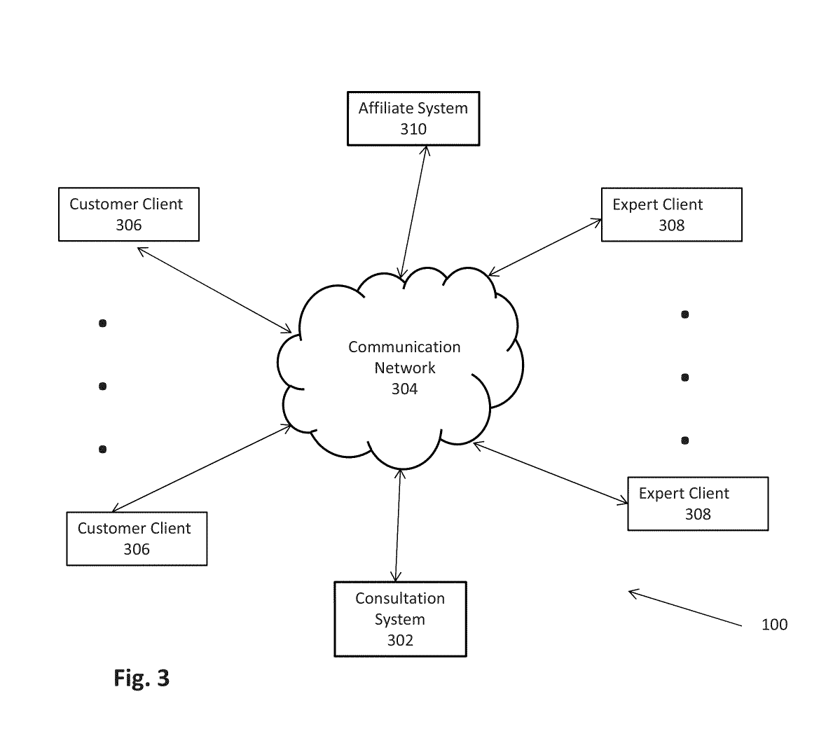

FIG. 3 shows an exemplary environment 300 in which embodiments of the present invention may be practiced. The exemplary environment 300 comprises an online consultation system 102 coupled via a communications network 304 to one or more customer client 306, (also referred to as the user client 306 hereafter) and expert client 308. The communication network 304 may comprise one or more local area networks or wide area networks such as, for example, the Internet and telephone systems.

In exemplary embodiments, the online consultation system 102 provides a forum where users may post or pose questions for which experts may provide answers. The online consultation system 102 may provide the forum via a website. In some embodiments, at least portions of the forum (e.g., asking of questions or receiving of responses) may occur via the website, mobile phone, other websites, text messaging, telephone, video, VoIP, or other computer software applications. Because the online consultation system 102 is network based e.g., Internet, public switched telephone network (PSTN), cellular network), the users using the online consultation system 102 and experts providing answers may be geographically dispersed (e.g., may be located anywhere in the world). As a result an expert may provide answers to a user thousands of miles away. Additionally, the online consultation system 102 allows a large number of users and experts to exchange information at the same time and at any time.

By using embodiments of the present invention, a user posting a question may easily obtain a tailored answer. Accordingly, the use of the online consultation system 102 discussed herein may obviate a need for additional searching for answers, which may have the technical effect of reducing computing resources used by one or more devices within the system. Examples of such computing resources include, without limitation, processor cycles, network traffic, memory usage, storage space, and power consumption.

In various embodiments, a user may pose a question and one or more experts may provide answers. In various embodiments, the question may be matched with a category of experts, more specific set of experts, or even individual experts, sometimes on a rotating basis by user selection, a keyword based algorithm, a quality based algorithm (or score or rating), or other sorting mechanism that may include considerations such as, for example, likely location or time zone. A back-and-forth communication can occur. The user may accept an answer provided by one or more of the experts. In an alternative embodiment, the user may be deemed to have accepted the answer if the user does not reject it. By accepting the answer, the user validates the expert's answer which, in turn, may boost a score or rating associated with the expert. The user may also pay the expert for any accepted answers and may add a bonus. The user may also leave positive, neutral or negative feedback regarding the expert.

The exemplary user client 306 is a device associated with a user accessing the consultation system 102 (e.g., via a website, telephone number, text message identifier, or other contact means associated with the online consultation system 102). The user may comprise any individual who has a question or is interested in finding answers to previously asked questions. The user client 306 comprises a computing device (e.g., laptop, PDA, cellular phone) which has communication network access ability. For example, the user client 306 may be a desktop computer initiating a browser for access to information on the communication network 304. The user client 306 may also be associated with other devices for communication such as a telephone.

In exemplary embodiments, the expert client 308 is a device associated with an expert. The expert, by definition, may be any person that has, or entity whose members have, knowledge and appropriate qualifications relating to a particular subject matter. Some examples of expert subject matters include health (e.g., dental), medical (e.g., eye or pediatrics), legal (e.g., employment, intellectual property, or personal injury law), car, tax, computer, electronics, parenting, relationships, and so forth. Almost any subject matter that may be of interest to a user for which an expert has knowledge and appropriate qualifications may be contemplated. The expert may, but does not necessarily need to, have a license, certification or degree in a particular subject matter. For example, a car expert may have practical experience working the past 20 years at a car repair shop. In some embodiments, the expert may be a user (e.g., the expert posts a question).

The expert client 308 may comprise a computing device (e.g., laptop, PDA, cellular phone) which has communication network access ability. For example, the expert client 308 may be a desktop computer initiating a browser to exchange information via the communication network 304 with the online consultation system 102. The expert client 308 may also be associated with other devices for communication such as a telephone.

In accordance with one embodiment, an affiliate system 310 may be provided in the exemplary environment 300. The affiliate system 310 may comprise an affiliate website or other portal which may include some of the components of the online consultation system 102 or direct their users to the online consultation system 102. The affiliate system 310 may also be associated with other devices for communication such as a telephone. For example, the affiliate system 310 may provide a website for a car group. A link or question box may be provided on the affiliate website to allow members of the car group to ask questions. Answers in response to the questions may be provided, in part, from the online consultation system 102, or the member asking the question may be directed to the online consultation system 102 for the answer. The members may, in some cases, only have access to certain categories or experts. In one embodiment, a RSS feed may be used to feed data from the consultation system 102 to the affiliate system 310. The users of the affiliate system 310 may be tagged with the affiliate depending on if and how the users are registered with the online consultation system 102. It should be noted that the affiliate system 310 may comprise any type or category of affiliate sites. In some cases, the affiliate system 310 may involve questions being answered by the affiliate or persons involved with the affiliate.

The environment 300 of FIG. 3 is exemplary. Alternative embodiments may comprise any number of online consultation systems 102, user clients 306, expert clients 308, and affiliate systems 310 coupled together via any type of one or more communication networks 304, and still be within the scope of exemplary embodiments of the present invention. For example, while only one online consultation system 102 is shown in the environment 300, alternative embodiments may comprise more than one online consultation system 102. For instance, the online consultation systems 102 may be regionally established.

### Modules, Components, and Logic

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry or in temporarily configured circuitry (e.g., configured by software) may be driven by, for example, cost, time, energy-usage, and package size considerations.

Accordingly, the term module or engine should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time.

For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Exemplary Machine Architecture and Machine-Readable Medium

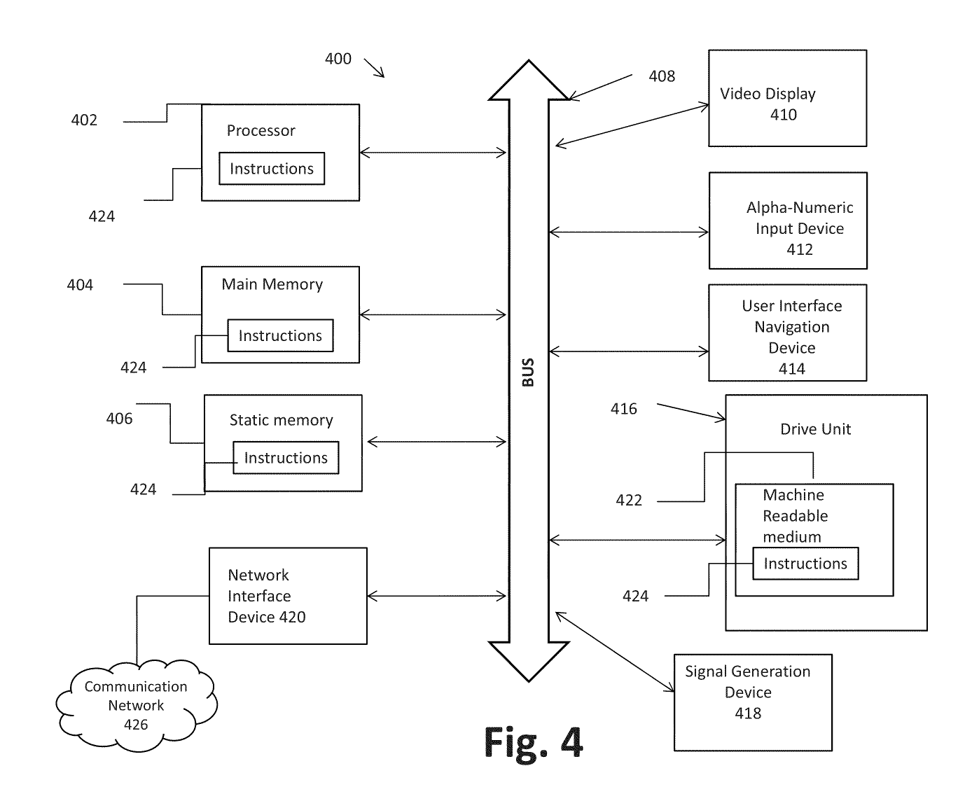

With reference to FIG. 4, an exemplary embodiment extends to a machine in the exemplary form of a computer system 400 within which instructions for causing the machine to perform any one or more of the methodologies discussed herein may be executed. In exemplary embodiments, the computer system 400 may be any one or more of the user client 306, the expert client 308, affiliate system 310, and servers of the consultation system 102. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 may include a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). In exemplary embodiments, the computer system 400 also includes one or more of an alpha-numeric input device 412 (e.g., a keyboard), a user interface (UI) navigation device or cursor control device 414 (e.g., a mouse), a disk drive unit 416, a signal generation device 418 (e.g., a speaker), and a network interface device 420.

### Machine-Readable Medium

The disk drive unit 416 includes a machine-readable medium 422 on which is stored one or more sets of instructions 424 and data structures (e.g., software instructions) embodying or used by any one or more of the methodologies or functions described herein. The instructions 424 may also reside, completely or at least partially, within the main memory 404 or within the processor 402 during execution thereof by the computer system 400, the main memory 404 and the processor 402 also constituting machine-readable media.

While the machine-readable medium 422 is shown in an exemplary embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media. Specific examples of machine-readable media include non-volatile memory, including by way of exemplary semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks. The term “machine-readable medium” shall also be taken to include any non-transitory storage medium.

### Transmission Medium

The instructions 424 may further be transmitted or received over a communications network 426 using a transmission medium via the network interface device 420 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure or resource. Similarly, structures and functionality presented as a single resource may be implemented as separate resources.

These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A computer implemented method of automatically identifying implicit topics contained in questions in an online consultation system, questions having been posted by a user to one of a variety of subject matter categories to be answered by a subject matter expert, the computer implemented method comprising:
using at least one processor to:
for each posted question in a database of questions posted to the online consultation system:
perform linguistic analysis to break down the question into component parts and extract candidate topics, wherein the candidate topics are words and phrases that include semantic meaning, and wherein each posted question is relates to a subject matter category;
create a topic model by counting the frequency of occurrence of each candidate topic with for each subject matter category,
selecting the candidate topics whose frequency of occurrence within the subject matter category is above at least one popularity threshold,
assigning to each selected candidate topic an affinity score, wherein the affinity score quantifies the affinity of each candidate topic to the subject matter category; and
identifying the selected candidate topics with an affinity score above a second threshold as the best topics for the subject matter category; and
for each original question, where the original question is the content related to a link the user clicked to land on a landing page of the online consultation system:
extracting candidate topics from the question of interest;
identifying the candidate topics present in the question of interest;
presenting the candidate topics to the user as implicit topics.

2. The method of claim 1, wherein the scoring is based on an importance measure.

3. The method of claim 4, wherein the scoring uses a modified TFIDF methodology.

4. A non-transitory machine-readable storage medium having embodied thereon instructions which when executed by at least one processor, causes a machine to perform operations comprising:
using at least one processor to:
for each posted question in a database of questions posted to the online consultation system:
perform linguistic analysis to break down the question into component parts and extract candidate topics, wherein the candidate topics are words and phrases that include semantic meaning, and wherein each posted question is relates to a subject matter category;
create a topic model by counting the frequency of occurrence of each candidate topic with for each subject matter category,
selecting the candidate topics whose frequency of occurrence within the subject matter category is above at least one popularity threshold,
assigning to each selected candidate topic an affinity score, wherein the affinity score quantifies the affinity of each candidate topic to the subject matter category; and
identifying the selected candidate topics with an affinity score above a second threshold as the best topics for the subject matter category; and
for each question original question, where the original question is the content related to a link the user clicked to land on a landing page of the online consultation system:
extracting candidate topics from the question of interest;
identifying the candidate topics present in the question of interest;
presenting the candidate topics to the user as implicit topics.
